(19) United States
(12) Patent Application Publication
(10) Pub. No.: US 2010/0123658 A1
(43) Pub. Date: May 20, 2010

(54) PORTABLE COMMUNICATION DEVICE HAVING A TOUCH-SENSITIVE INPUT DEVICE WITH NON-LINEAR ACTIVE AREAS

(75) Inventors: Randolph C. Demuynck, Wake Forest, NC (US); Paul Futter, Cary, NC (US); Stephen Caudle, Raleigh, NC (US); Kevin M. Shay, Cary, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/272,479

(22) Filed: Nov. 17, 2008

(51) Int. Cl. G09G 5/08; G06F 3/041

(52) U.S. Cl. 345/157; 345/173

(57) ABSTRACT

A portable communication device includes a touch-sensitive input device that is configured to include a substantially V-shaped active area. The portable communication device is configured to facilitate character selection and navigation by sensing the user's thumb position on and movement along the substantially V-shaped active area. The portable communication device is configured to provide keypad functionality via the touch-sensitive input device without a graphical representation of character keys and/or navigation keys represented on the touch-sensitive input device.

### TECHNICAL FIELD OF THE INVENTION

The present invention relates generally to portable communication devices, and more particularly, to a portable communication device having a touch-sensitive input device with non-linear active areas.

### DESCRIPTION OF RELATED ART

In recent years, portable communication devices, such as mobile phones, personal digital assistants, mobile terminals, etc., continue to grow in popularity. As the popularity of portable communication devices continues to grow, the applications for and features of portable communication devices continue to expand. Portable communication devices are appealing to users because of their capability to serve as powerful communication, data service and entertainment tools.

Most mobile phones include a liquid crystal display (LCD) to accommodate the information display requirements associated with today's mobile phones. In addition, touch-sensitive input devices, such as touch screens and touch keypads, have become popular. These devices allow for user input by touching the screen or other touch-sensitive area with a finger or stylus. Touch-sensitive keypads are useful for many applications in the mobile phone environment. Some benefits associated with touch-sensitive keypads include being thinner and easier to clean than mechanical buttons, allowing for easier sealing against water and environmental dirt, and providing reconfigurable button areas, e.g., soft keys, and permitting adaptable keypads.

### SUMMARY

To enhance functionality and versatility, a portable communication device is provided with a touch-sensitive input device configured to include non-linear active areas. The touch-sensitive input device is configured to include a substantially V-shaped active area such that the position of the user's thumbs on and/or movement along the substantially V-shaped active area determines character selection and navigation functions for all of the device usage modes. As such, the portable communication device is configured to provide keypad functionality via the touch-sensitive input device without a graphical representation of character keys and/or navigation keys on the touch-sensitive input device. The provision of a portable communication device having a touch-sensitive input device with non-linear active areas allows for a low-cost and space-saving keypad that can be universally with a multitude of devices throughout the world.

One aspect of the disclosed technology relates to a portable communication device that includes a housing; a display disposed within the housing; and a touch-sensitive input device disposed within the housing, wherein the touch-sensitive input device is configured to include a substantially V-shaped active area.

According to one feature, the portable communication device is configured to receive character entry by way of sensing a user's thumb position on and movement along the substantially V-shaped active area.

According to one feature, the portable communication device is configured to receive navigational input by way of sensing a user's thumb position on and movement along the substantially V-shaped active area.

According to one feature, the portable communication device is configured to provide keypad functionality via the touch-sensitive input device without a graphical representation of character keys and/or navigation keys on the touch-sensitive input device.

According to one feature, the touch-sensitive input device is the sole text input device for the portable communication device.

According to one feature, the touch-sensitive input device is the sole navigational input device for the portable communication device

According to one feature, the portable communication device is configured to provide navigation along three directions by way of sensing user input via the substantially V-shaped active area.

According to one feature, the touch-sensitive input device comprises a pair of arcuate sensor areas that cooperate to define the substantially V-shaped active area.

According to one feature, the pair of arcuate sensor areas is comprised of force-sensitive resistive sensors.

According to one feature, the pair of arcuate sensor areas is comprised of capacitive sensors.

According to one feature, the touch-sensitive input device is configured to provide navigation along three directions by way of sensing user contact along the substantially V-shaped active area.

According to one feature, the housing includes a top portion and a base portion, with the display disposed within the top portion and the touch-sensitive input device disposed within the base portion, wherein the top portion and the base portion are coupled by a sliding hinge assembly configured to provide sliding motion between the top portion and the base portion and rotation of the top portion relative to the base portion

According to one feature, the portable communication device is a mobile telephone.

Another aspect of the disclosed technology relates to a portable communication device that includes a touch-sensitive input device having a length dimension and a width dimension, the touch-sensitive input device including an active area configured to receive user input along directions at an angle to the length dimension and the width dimension.

According to one feature, the touch-sensitive input device includes a plurality of active areas configured to receive user input along directions parallel to and at an angle to the length dimension and the width dimension.

According to one feature, the touch-sensitive input device is disposed within a housing, wherein the touch-sensitive input device is positioned, sized and configured to be held by a user with both hands, and the active area is positioned and sized to substantially match a path followed by a user's thumbs when the user's thumbs are moved over the touch-sensitive input device while holding the portable communication device.

According to one feature, the touch-sensitive input device is configured to include a substantially V-shaped active area.

Another aspect of the disclosed technology relates to a universal input device configured for use with a portable communication device, wherein the universal input device includes a touch-sensitive input device configured to include a substantially V-shaped active area.

According to one feature, the active area includes a force sensitive resistor disposed in a substantially V-shaped configuration

According to one feature, the universal input device is disposed in combination with a display and a graphical user interface displayed on the display, wherein the graphical user interface cooperates with the touch-sensitive input device such that character input is achieved by using the touch-sensitive input device to select characters displayed on the display.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended thereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is a perspective view of an exemplary portable communication device in a closed position;

FIG. 2 is a perspective view of the portable communication device of FIG. 1 in a partially open position;

FIG. 3 is a perspective view of the portable communication device of FIG. 1 in a fully open position;

FIG. 4 is a block diagram of the exemplary portable communication device of FIG. 1;

FIG. 5 is a diagrammatic illustration of the portable communication device of FIG. 1 in connection with one exemplary mode of usage;

FIG. 6 is a diagrammatic illustration of the portable communication device of FIG. 1 in connection with another exemplary mode of usage;

FIG. 7 is a diagrammatic illustration of the portable communication device of FIG. 1 in connection with another exemplary mode of usage;

FIG. 8 is a diagrammatic illustration of the portable communication device of FIG. 1 in connection with another exemplary mode of usage; and

FIG. 9 is a diagrammatic illustration of the portable communication device of FIG. 1 in connection with another exemplary mode of usage.

### DETAILED DESCRIPTION OF EMBODIMENTS

In the detailed description that follows, like components have been given the same reference numerals regardless of whether they are shown in different embodiments of the present invention. To illustrate the present invention in a clear and concise manner, the drawings may not necessarily be to scale and certain features may be shown in somewhat schematic form.

As referred to herein, the term “portable communication device” includes portable radio communication equipment. The term “portable radio communication equipment”, which herein after is referred to as a mobile phone, a mobile device, a mobile radio terminal or a mobile terminal, includes all electronic equipment, including, but not limited to, mobile telephones, pagers, communicators, i.e., electronic organizers, smartphones, personal digital assistants (PDAs), or the like. While the disclosed technology is being discussed with respect to portable communication devices, it is to be appreciated that the invention is not intended to be limited to portable communication devices, and can be applied to any type of handheld mobile electronic equipment having a touch-sensitive input device with a non-linear and/or substantially V-shaped active area.

In the context of the illustrated embodiments, the portable communication device is primarily referred to as a mobile telephone or a mobile phone. The description and illustrations of the mobile telephone, however, are intended to serve as a non-limiting exemplary environment for the inventive concepts described herein, and it will be appreciated that the invention is not intended to be limited to a mobile telephone, but rather can be any type of electronic equipment.

While features and functionality of portable communication devices, (e.g., mobile phones) continue to increase, manufacturers and designers of portable communication devices frequently seek to reduce the overall cost and dimensions (e.g., footprint and overall thickness) of portable communication devices, while maintaining attractive style characteristics.

Many portable communication devices now include full QWERTY keypads, especially in devices used primarily as youth messaging devices. The present disclosure recognizes a problem with traditional QWERTY keypads in the amount of area required for implementation. Further, the present disclosure recognizes a problem with traditional keypads in that companies must provide a unique keypad for each region of the world in which the portable communication device is being marketed.

In solving these problems, the present disclosure details a method and apparatus for replacing the traditional input devices used for selection and navigation operations of mobile phones. The disclosed portable communication device includes a touch-sensitive input device that serves to reduce the total amount of operations necessary for selection and navigation. The typical operations (e.g., “hunt and peck”) have been reduced to the user moving his/her thumbs across a non-linear or substantially V-shaped active area on the keypad. The substantially V-shaped active area allows for user movement analogous to the natural movement of the user's thumbs over a smooth surface (e.g., wiper action).

To enhance functionality and versatility, a portable communication device is provided with a touch-sensitive input device configured to include non-linear active areas. The touch-sensitive input device is configured to include a substantially V-shaped active area such that the position of the user's thumbs on and/or movement along the substantially V-shaped active area determines character selection and navigation functions for all of the device usage modes. It will be appreciated that “substantially V-shaped” may include a pair of arcuate sensors that do not meet at a point.

As such, the portable communication device is configured to provide keypad functionality via the touch-sensitive input device without a graphical representation of character keys and/or navigation keys represented on the touch-sensitive input device.

In solving these problems, the disclosed portable communication device includes a low-cost alternative to traditional QWERTY keypads, which can be used universally throughout the world. Further, the disclosed portable communication device provides a universal touch-sensitive input device having greater versatility and reduced dimensions.

As is described more fully below, the portable communication device may be configured to operate in a plurality of usage modes in which the position of the user's thumbs on and/or movement along the substantially V-shaped active area determines the selection and navigation, where the active area is completely programmable depending on the particular usage mode.

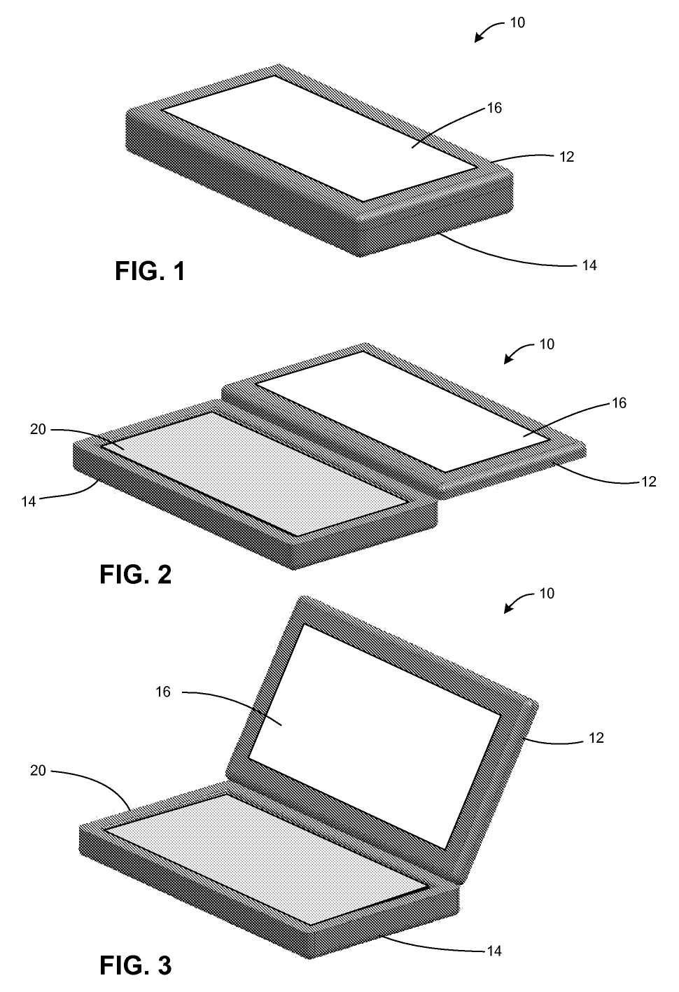

Referring initially to FIGS. 1-3, an exemplary embodiment of a portable communication device 10 (e.g., a mobile phone, mobile terminal or the like) is shown. In FIG. 1, the portable communication device is shown as it would appear when operating in what is conventionally referred to as a “standby” mode. In the illustrated embodiment, the mobile phone 10 includes a top portion 12 coupled to a base portion 14 by a hinge assembly that allows or otherwise facilitates sliding motion between the top portion 12 and the base portion 14 (FIG. 2) as well as rotational motion between the top portion 12 and the base portion 14 (FIG. 3). In one embodiment, the mobile phone is configured such that the top portion 12 can be slid relative to the base portion 14 and rotated up into a position resembling an open laptop computer. Other hinge assemblies may be employed without departing from the scope of the present invention. Also, while aspects of the present invention are being described with respect to a mobile phone 10 that includes a top portion and a base portion, it will be appreciated that the present invention may also be applied to other form factors and configurations, for example, mobile phones having a “block” or “candy bar” type of housing, other slide-housings and/or other clamshell-type housings.

In the illustrated embodiment, the top portion 12 includes or otherwise houses a display 16, while the base portion includes or otherwise houses a non-linear touch-sensitive input device 20 (also referred to as a touch-sensitive input device, a touch-sensitive input device having a substantially V-shaped active area, or simply a V-pad).

In the illustrated exemplary embodiment, FIGS. 1-3 show that the display 16 within the top portion 12 would be exposed when the mobile phone 10 is in a closed configuration. Further, the display 16 would be viewable by the user when the top portion 12 is slid or otherwise translated and rotated into a substantially upright position relative to the base portion 14.

The display 16 may include any suitable display (e.g., a dedicated LCD) configured to display information to a user, such as, operating state, time, telephone numbers, contact information, menus, text entry options, navigational menus and the like. Alternatively, it will be appreciated that the portable communication device may be configured without a display or other visual feedback device. As is described more fully below, the non-linear touch-sensitive input device 20 is configured to include a substantially V-shaped active area that may be used for text entry, selection and navigational operations. In such an embodiment, the touch-sensitive input device cooperates with a suitable graphical interface such that characters may be selected based on the user's thumb position on and movement along the substantially V-shaped active area of the touch-sensitive input device with no text entry characters displayed or otherwise graphically represented on the touch-sensitive input device 20 itself. Rather, the touch-sensitive input device cooperates with the graphical user interface to allow a user to select text entry characters and/or words.

As is described more fully below, the touch-sensitive input device 20 is configured to accept user input for a variety of functional and/or navigational user input operations. For example, the substantially V-shaped active area of the touch-sensitive input device may allow a user to select special function keys for initiating or answering a call as well as menu navigation keys, for example, for navigating through a menu displayed on the display 16 to select different telephone functions, profiles, settings and the like. Other navigational operations may include directional navigation to highlight different links or icons or to navigate text or other documents. Also, the touch-sensitive input device may allow for other analog type functions such as an on/off power key, a web browser launch key, a camera key and the like.

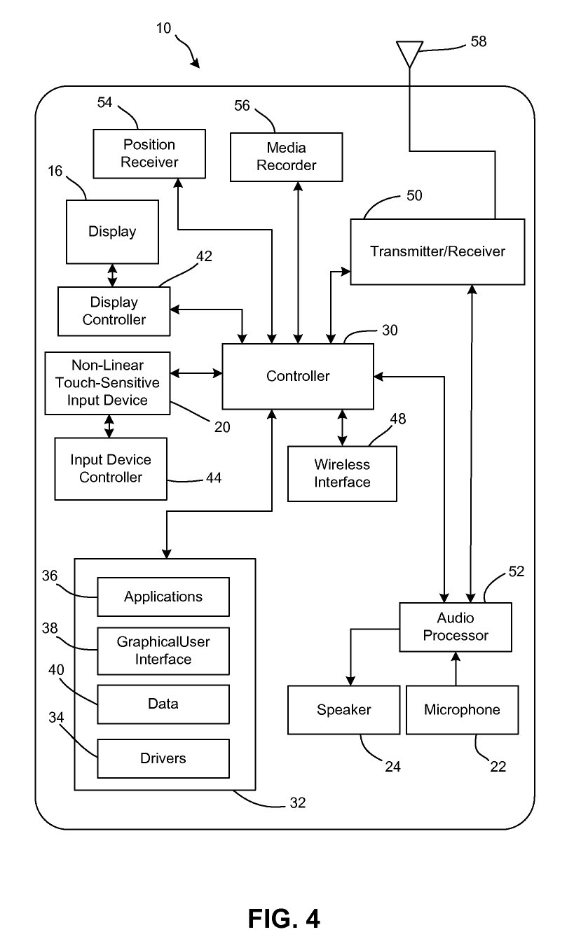

FIG. 4 represents a functional block diagram of a portable communication device 10. The portable communication device 10 includes a controller 30 that controls the overall operation of the portable communication device. The controller 30 may include any commercially available or custom microprocessor or microcontroller. Memory 32 is operatively connected to the controller 30 for storing control programs and data used by the portable communication device. The memory 32 is representative of the overall hierarchy of memory devices containing software and data used to implement the functionality of the portable communication device in accordance with one or more aspects described herein. The memory 32 may include, for example, RAM or other volatile solid-state memory, flash or other non-volatile solid-state memory, a magnetic storage medium such as a hard disk drive, a removable storage media, or other suitable storage means. In addition to handling voice communications, the portable communication device 10 may be configured to transmit, receive and process data, such as web data communicated to and from a web server, text messages (also known as short message service or SMS), electronic mail messages, multimedia messages (also known as MMS), image files, video files, audio files, ring tones, streaming audio, streaming video, data feeds (e.g., podcasts) and so forth.

In the illustrated embodiment, memory 32 stores drivers 34 (e.g., I/O device drivers), application programs 36, a graphical user interface 38, and application program data 40. The I/O device drivers include software routines that are accessed through the controller 30 (or by an operating system (not shown) stored in memory 32) by the application programs, and graphical user interface to communicate with devices such as the touch-sensitive input device 20 and the substantially V-shaped active area provided on the touch-sensitive input device, as well as other input/output ports. In one embodiment where the mobile phone includes a dedicated display 16, the display 16 may be operatively coupled to and controlled by a display controller 42 (e.g., a suitable microcontroller or microprocessor).

The application programs 36 as well as the graphical user interface 38, comprise programs that implement various features of the portable communication device, such as voice calls, e-mail, Internet access, multimedia messaging, contact manager and the like. As is described more fully below, the graphical user interface comprises a program, logic routine, code or circuitry that cooperates with the touch-sensitive input device 20 to facilitate character entry and/or navigation by way of the substantially V-shaped active area of the touch-sensitive input device.

In one embodiment, the touch-sensitive input device 20 is operatively coupled to and controlled by an input device controller 44 (e.g., a suitable microcontroller or microprocessor) and configured to facilitate touch input functionally (detection of user touch of the substantially V-shaped active area and recognition of desired user input based on the touch of the substantially V-shaped active area of the touch-sensitive input device). In a preferred embodiment, the touch-sensitive input device 20 cooperates with the graphical user interface 38, as presented on the display 16, to facilitate character selection, navigation and other functionality without text entry characters displayed or otherwise graphically represented on the touch-sensitive input device 20 itself. Rather, the touch-sensitive input device cooperates with the graphical user interface to allow a user to select text entry characters and/or words that are depicted on the display.

With continued reference to FIG. 4, the controller 30 interfaces with the aforementioned touch-sensitive input device 20 (and any other user interface device(s)), a transmitter/receiver 50 (often referred to as a transceiver), audio processing circuitry, such as an audio processor 52, and a position determination element or position receiver 54, such as a global positioning system (GPS) receiver. The portable communication device 10 may include a media recorder 56 (e.g., a still camera, a video camera, an audio recorder or the like) that captures digital pictures, audio and/or video. Image, audio and/or video files corresponding to the pictures, songs and/or video may be stored in memory 32.

An antenna 58 is coupled to the transmitter/receiver 50 such that the transmitter/receiver 50 transmits and receives signals via antenna 58, as is conventional. The portable communication device includes an audio processor 52 for processing the audio signals transmitted by and received from the transmitter/receiver. Coupled to the audio processor 52 are the speaker 22 and microphone 24, which enable a user to listen and speak via the portable communication device. Audio data may be passed to the audio processor 52 for playback to the user. The audio data may include, for example, audio data from an audio file stored in the memory 32 and retrieved by the controller 30. The audio processor 52 may include any appropriate buffers, decoders, amplifiers and the like.

The portable communication device also may include one or more local wireless interfaces, such as an infrared transceiver and/or an RF adapter, e.g., a Bluetooth adapter, WLAN adapter, Ultra-Wideband (UWB) adapter and the like, for establishing communication with an accessory, a hands free adapter, e.g., a headset that may audibly output sound corresponding to audio data transferred from the portable communication device 10 to the adapter, another mobile radio terminal, a computer, or any other electronic device. Also, the wireless interface may be representative of an interface suitable for communication within a cellular network or other wireless wide-area network (WWAN).

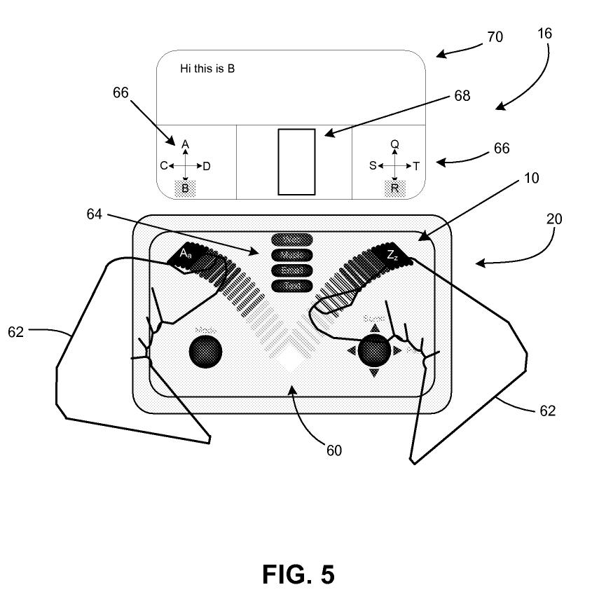

Turning now to FIG. 5, an exemplary diagrammatic illustration of the portable communication device 10 is provided, including the display 16 and the touch-sensitive input device 20. In a preferred embodiment, the touch-sensitive input device 20 is configured to include a substantially V-shaped active area 60 comprised of a pair of curved or arcuate sensor regions. The curved sensor regions that cooperate to form the substantially V-shaped active area 60 may be comprised on a pair of curved force sensing resistors printed on a flexible substrate. Suitable resistive sensors may be acquired from Interlink Electronics. Force sensing resistors operate such that the resistance of the sensor is altered by the application of finger pressure. For purposes of explanation, user's thumbs are illustrated and indicated generally by reference number 62. In a preferred embodiment, the active area includes a pair of arcs printed in a substantially V-shaped configuration that substantially matches the natural range of motion of a user's thumbs while the user is holding the device. The sensors can detect finger movement in the X, Y and Z directions, thereby providing three-dimensional navigation and selection based on the user's thumb position on and movement along the substantially V-shaped active.

Alternatively, other touch-sensitive sensor technology may be employed, such as capacitive sensor technology or electroluminescent (EL) sensor technology. As is discussed more fully below, movement along each portion of the substantially V-shaped active area can provide X and Y navigation or scrolling, while Z pressure can be used as a select function. The position of the user's thumbs along the active area determines a selection, with the active area being completely programmable and configured to cooperate with the graphical user interface depending on the mode of operation. For example, A through Z can be mapped as depicted in FIG. 5 or, alternatively, the left side of the substantially V-shaped active area can be used for course navigation, while the right side can be used for fining tuning/selection. The user input is aided by on-screen navigation applications provided by the graphical user interface.

The touch-sensitive input device 20 may be further aided by light emitting diodes (LEDs) or other indicators below the surface of the touch-sensitive input device the illuminate when the user's thumb rolls across the active area 60. Optionally, the touch-sensitive input device may be configured to include additional analog navigation controls and hot keys 64 to facilitate gaming and/or web browsing applications.

As shown, the graphical user interface on the display is configured to cooperate with the touch-sensitive input display to facilitate character selection, text entry and navigation without the need for depicting an alphanumeric keypad or a portion of an alphanumeric keypad on the touch-sensitive input device. For example, FIG. 5 shows a graphical user interface that includes a pair of navigation panes 66 that illustrate various alphanumeric characters that are selectable by a user through navigation using the substantially V-shaped active area of the touch-sensitive input device. It will be appreciated that the characters displayed in the navigation panes 66 may be dynamically updated though predictive key mapping (e.g., displaying the eight most frequently used characters or keys). The navigation pane(s) may be configured in a number of ways depending upon the particular active application or usage mode. The graphical user interface may be configured with other windows or features, for example, configured to include a user-configurable image area 68, as well as a main content viewing window 70, for example, for viewing composed text and received text.

It will be appreciated that other graphical user interface modes may be provided for text entry. For example, in one embodiment, the navigation pane may include coarse navigation (alphanumeric navigation) by way of the left-hand side of the substantially V-shaped active area and word selection by way of the right hand side of the substantially V-shaped active area. It will be appreciated that the above-described touch-sensitive input device and graphical user interface eliminates the need for the user to look at the keypad for text entry or navigation.

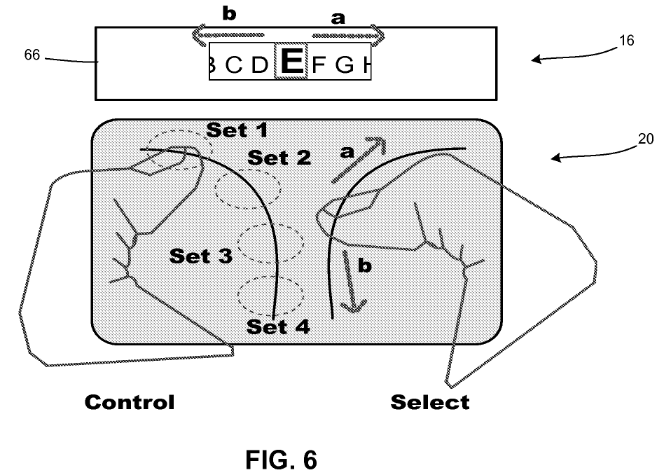

Turning now to FIGS. 6-9, several exemplary applications or usage modes involving the non-linear touch-input device are discussed. The following examples provide details on user input software used to translate V-pad finger movements into user input for various modes. It will be appreciated that the following are some exemplary implementations and actual additional or alternative implementations may be employed depending on sensor resolution, size and the like without departing from the scope of the present invention. Further, the presented examples assume a right-handed user. Because the V-pad is completely programmable, it may be configured for either right or left-hand usage. For example, a software configurable setting may be used to support left-handed users and swap the functionality of the left and right sliders when enabled.

FIG. 6 illustrates a character input mode where the V-pad is used to input a series of characters. It will be appreciated that this mode may be entered in any application component that requires character input. In the illustrated exemplary embodiment, the left portion of the active area 60 provides control functionality and is used to vertically scroll between different character sets (e.g., alpha, numeric, emoticons, and the like). As the user changes the control finger location, the on/screen navigation pane's 66 displayed character set changes. In this exemplary configuration, the right sensor provides select functionality, and is used to horizontally scroll through the character set and select characters as shown in FIG. 6.

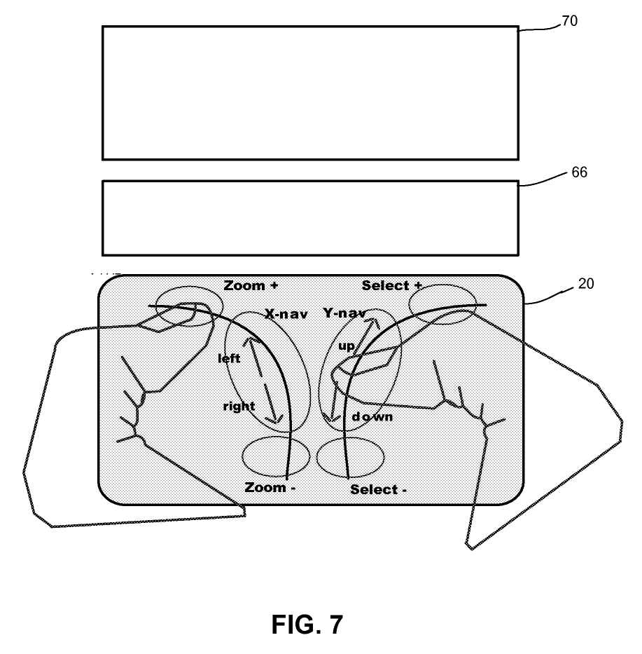

FIG. 7 shows another exemplary usage mode in which the v-pad is used in a navigation mode to navigate in any application that requires panning, zooming, and/or item selection, including, but not limited to a web browser or image viewer application. In the exemplary illustrated embodiment, the left sensor or left portion of the active area is used to pan in the negative X direction when sliding up and the positive X direction when sliding down. Pressing/tapping on the top of the left sensor without sliding may zoom in the negative Z direction. Pressing/tapping on the bottom of the left sensor without sliding may zoom in the positive Z direction. The right sensor may be used to pan in the positive Y direction when sliding up and the negative Y direction when sliding down. Pressing/tapping on the top of the right sensor without sliding will move the item selection up the page. Pressing/tapping on the bottom of the right sensor without sliding will move the item selection down the page. Navigation location on the screen may be provided by way of a graphical pointer overlay on the screen image. When the pointer is over a selectable item (e.g., component or hyperlink) the pointer icon may change to reflect that the item is selectable. Pressing/tapping on the center of the left or right sensor without moving will activate the item currently under the pointer. Of course, the V-pad may be programmed to provide other navigation configurations beside that described above without departing from the scope of the present invention.

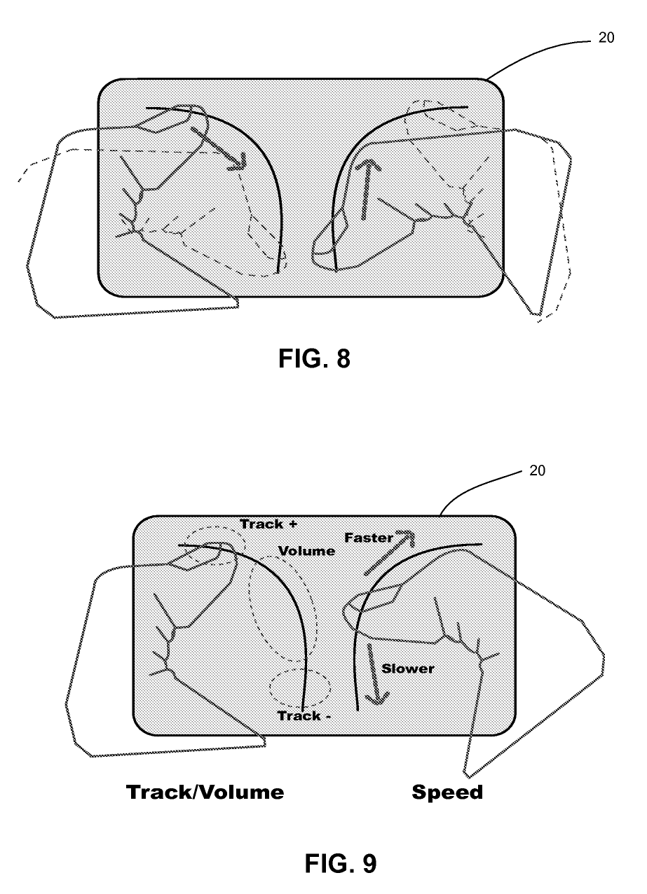

FIG. 8 shows another exemplary usage mode in which the V-pad is operated in a keylock mode. In this mode, the V-pad can be used to unlock the phone when the phone is in a locked mode. In one exemplary embodiment, after a period of inactivity, the phone automatically enters a locked mode where the input does not work to prevent accidental key input, for example, when the phone is in the user's pocket. Typically, the keylock mode provides a way to switch the phone about the locked state so that key input may resume. In the illustrated exemplary embodiment, the phone may exit the keylock mode when the left sensor is slid from top to bottom and the right sensor is slid from bottom to top in one coordinated motion or within a predetermined time period.

FIG. 9 shows another exemplary usage mode in which the V-pad is operated in a music or media mode, including a DJ scratchpad feature. In the DJ scratchpad mode, the V-pad allows a user to alter and/or create different sounds during musical playback and/or recording. In accordance with one exemplary embodiment, the left and right sensors are used to slow down, speed up and/or stop music b sliding up and down and pressing on the sliders similar to a DJ scratching pad.

While the portable communication device has been described above with respect to various exemplary usage cases, it will be appreciated that other applications and usage cases or modes may be provided. For example, the V-pad could be used in many different ways in a gaming mode to provide an alternate and exciting method of playing games. New games could be designed specifically around the V-pad mode of operation.

The provision of a mobile phone having a touch-sensitive input device configured to include a substantially V-shaped active area provides enhanced functionality and versatility. For example, a mobile phone having a V-pad in conjunction with a suitable graphical user interface allows a user to experience the same interaction with a common V-pad with adaptability to all phone functions (music, character entry, navigation)—the same interaction with different software implementation. Further, the V-shaped active area can allow for a touch-sensitive input device that fits into a variety of smaller form factors.

The mobile phone is configured without keys represented or otherwise depicted on the touch-sensitive input device, but still provides keypad functionality to do everything normally done with a phone (navigation and character entry) simply by the user moving his/her thumbs along the substantially V-shaped active area.

While the portable communication device has been described with respect to a graphical user interface designed around text or character entry, it will be appreciated that the present invention also applies to a strictly graphical user interface where the V-pad is used to select graphical symbols independent of text entry. This mode may be useful in areas not accustomed to alphanumeric text entry where the user simply slides along the V-pad to select a phone icon and a picture of someone they would like to call.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A portable communication device comprising:
a housing;
a display disposed within the housing; and
a touch-sensitive input device disposed within the housing, wherein the touch-sensitive input device is configured to include a substantially V-shaped active area.

2. The portable communication device of claim 1, wherein the portable communication device is configured to receive character entry by way of sensing a user's thumb position on and movement along the substantially V-shaped active area.

3. The portable communication device of claim 2, wherein the portable communication device is configured to receive navigational input by way of sensing a user's thumb position on and movement along the substantially V-shaped active area.

4. The portable communication device of claim 1, wherein the portable communication device is configured to provide keypad functionality via the touch-sensitive input device without a graphical representation of character keys and/or navigation keys on the touch-sensitive input device.

5. The portable communication device of claim 4, wherein the touch-sensitive input device is the sole text input device for the portable communication device.

6. The portable communication device of claim 5, wherein the touch-sensitive input device is the sole navigational input device for the portable communication device

7. The portable communication device of claim 1, wherein the portable communication device is configured to provide navigation along three directions by way of sensing user input via the substantially V-shaped active area.

8. The portable communication device of claim 1, wherein the touch-sensitive input device comprises a pair of arcuate sensor areas that cooperate to define the substantially v-shaped active area.

9. The portable communication device of claim 8, wherein the pair of arcuate sensor areas is comprised of force-sensitive resistive sensors.

10. The portable communication device of claim 8, wherein the pair of arcuate sensor areas is comprised of capacitive sensors.

11. The portable communication device of claim 1, wherein the touch-sensitive input device is configured to provide navigation along three directions by way of sensing user contact along the substantially V-shaped active area.

12. The portable communication device of claim 1, wherein the housing includes a top portion and a base portion, with the display disposed within the top portion and the touch-sensitive input device disposed within the base portion, wherein the top portion and the base portion are coupled by a sliding hinge assembly configured to provide sliding motion between the top portion and the base portion and rotation of the top portion relative to the base portion

13. The portable communication device of claim 1, wherein the portable communication device is a mobile telephone.

14. A portable communication device comprising:
a touch-sensitive input device having a length dimension and a width dimension, the touch-sensitive input device including an active area configured to receive user input along directions at an angle to the length dimension and the width dimension.

15. The portable communication device of claim 14, wherein the touch-sensitive input device includes a plurality of active areas configured to receive user input along directions parallel to and at an angle to the length dimension and the width dimension.

16. The portable communication device of claim 14, wherein the touch-sensitive input device is disposed within a housing, wherein the touch-sensitive input device is positioned, sized and configured to be held by a user with both hands, and the active area is positioned and sized to substantially match a path followed by a user's thumbs when the user's thumbs are moved over the touch-sensitive input device while holding the portable communication device.

17. The portable communication device of claim 14, wherein the touch-sensitive input device is configured to include a substantially V-shaped active area.

18. A universal input device configured for use with a portable communication device, wherein the universal input device comprises:
a touch-sensitive input device configured to include a substantially V-shaped active area.

19. The universal input device of claim 18, wherein the active area includes a force sensitive resistor disposed in a substantially V-shaped configuration

20. The universal input device of claim 18, in combination with a display and a graphical user interface displayed on the display, wherein the graphical user interface cooperates with the touch-sensitive input device such that character input is achieved by using the touch-sensitive input device to select characters displayed on the display.
